(19) United States
(12) Patent Application Publication
(10) Pub. No.: US 2024/0179726 A1
(43) Pub. Date: May 30, 2024

(54) Methods, UE, Relay UE, and Network Node for Communication Over Sidelink

(71) Applicant: Telefonaktiebolaget LM Ericsson (publ), Stockholm (SE)

(72) Inventors: Min Wang, Luleå (SE); Zhang Fu, Stockholm (SE); Zhang Zhang, Beijing (CN)

(21) Appl. No.: 18/548,232

(22) PCT Filed: Mar. 30, 2022
(86) PCT No.: PCT/CN2022/083969

§ 371 Date: Aug. 29, 2023

(30) Foreign Application Priority Data
Mar. 31, 2021 (WO) PCT/CN2021/084605

(51) Int. Cl. H04W 72/25; H04W 88/04; H04W 92/18

(52) U.S. Cl. CPC H04W 72/25; H04W 88/04; H04W 92/18

(57) ABSTRACT

The present disclosure is related to a user equipment (UE), a relay UE, a network node, and methods for communication over sidelink. The method at a user equipment (UE) for communicating with a network node for relaying the communication over a sidelink comprises: determining a relay option at least partially based on the UE's configuration and/or an indication received from the network node or another UE; determining zero or at least one relay UE at least partially based on the determined relay option; and in response to determining at least one relay UE, communicating with the at least one relay UE to attempt establishing the sidelink for the UE.

### CROSS-REFERENCE TO RELATED APPLICATION(S)

This application claims priority to the PCT International Application No. PCT/CN2021/084605, entitled “METHODS, UE, RELAY UE, AND NETWORK NODE FOR COMMUNICATION OVER SIDELINK”, filed on Mar. 31, 2021, which is incorporated herein by reference in its entirety.

### TECHNICAL FIELD

The present disclosure is related to the field of telecommunications, and in particular, to a user equipment (UE), a relay UE, a network node, and methods for communication over sidelink.

### BACKGROUND

Networks have always been hierarchical in nature. Devices have connected to and communicated with one or more base stations ever since the birth of cellular communications. However, new technology enablers in 5G New Radio (NR) will allow devices to connect directly to one another using a technique called sidelink communications. Sidelink is the new communication paradigm in which cellular devices are able to communicate without relaying their data via the network. That means vehicles, robots, and even consumer gadgets could create their own ad hoc networks without using the radio access network as an intermediary.

In the past decade new types of cellular services that go beyond traditional mobile broadband have had a strong impact on the scoping and development of the 5G NR standard. These new cellular services were motivated by the business and economic needs of making the 3GPP ecosystem capable of supporting industrial requirements ranging from direct automotive communication between vehicles to industrial automation with Ultra-Reliable Low-Latency Communication (URLLC) for mission- and business-critical applications. But these same technologies can also be used for consumers to enhance their communication experience. For instance, sidelink proximity services would allow devices to discover and communicate with one another at extremely high data rates and low latency, making them ideal for peer-to-peer gaming and streaming services as well as enhanced AR, VR and other wearable device communications.

In contrast with uplink and downlink between a user equipment (UE) and a base station, where resource allocation and link adaptation are controlled by the network, in sidelink the device performs both functions autonomously. In other words, the device gains more control of how to use network resources. At the same time, it is expected that 3GPP upcoming Release will introduce support for sidelink-based relaying and that in future releases multi-link relay will also be considered. Sidelink is also a candidate for future releases as an Industrial Internet of Things (IOT) enabler. By restricting the communication link to one hop, latency is greatly reduced, which is key to mission-critical industrial applications. Furthermore, sidelink is a potential solution for public safety ensuring direct communication or relayed communication between devices.

Another potential use case is multi-hop relaying where multiple sidelink connections are used to leap from/to device to achieve less power consumption, overcome link budget constraints, and enhance latency and reliability. Gaming and entertainment services with AR/VR can also take advantage of sidelink, as will body networks, using direct 5G connections to replace the Bluetooth and eventually Wi-Fi links that currently connect these devices. The result could be a revolutionary change in the communication architecture for many consumer devices. Instead of providing a different radio interface for every use case, device vendors could rely solely on 5G as the link for wide-area, local-area and personal-area communications.

### SUMMARY

According to a first aspect of the present disclosure, a method at a user equipment (UE) for communicating with a network node is provided. In some embodiments, the communication is relayed over a sidelink. The method comprises: determining a relay option at least partially based on the UE's configuration and/or an indication received from the network node or another UE; determining zero or at least one relay UE at least partially based on the determined relay option; and in response to determining at least one relay UE, communicating with the at least one relay UE to attempt establishing the sidelink for the UE.

In some embodiments, the relay option comprises one of: —L2 relaying is supported; —L3 relaying is supported; and—both L2 relaying and L3 relaying are supported. In some embodiments, the UE's configuration comprises its relaying capability and/or relaying preference. In some embodiments, the step of determining a relay option at least partially based on the UE's configuration and/or an indication received from the network node or another UE comprises: determining the relay option based on the indication received from the network node or the other UE in response to determining that the UE's configuration is different from the configuration or configuration on relay option indicated by the network node or the other UE. In some embodiments, the UE's configuration is configured and/or preconfigured in Mobile Equipment (ME) or Universal Integrated Circuit Card (UICC) of the UE. In some embodiments, the indication is received from the network node or the other UE via broadcasted system information, dedicated Radio Resource Control (RRC) signaling, and/or a Medium Access Control (MAC) Control Element (CE).

In some embodiments, the step of determining zero or at least one relay UE at least partially based on the determined relay option comprises: broadcasting or transmitting, to each of one or more neighboring UEs, a discovery message indicating the determined relay option; and receiving, from each of one or more of the neighboring UEs, an indication, each indication indicating that the determined relay option is supported at a corresponding neighboring UE as a candidate relay UE; and determining at least one of the one or more candidate relay UEs as the determined relay UE.

In some embodiments, the step of determining zero or at least one relay UE at least partially based on the determined relay option comprises: receiving, from one or more candidate relay UEs, one or more discovery messages comprising one or more indications indicating their relay options, respectively; and determining at least one of the one or more candidate relay UEs as the determined relay UE at least partially based on the determined relay option and the received one or more indications. In some embodiments, at least one of the received indications indicates that a relay option of a corresponding candidate relay UE is supported by its serving or camping network node.

In some embodiments, the step of determining at least one of the one or more candidate relay UEs as the determined relay UE comprises: determining, from the one or more candidate relay UEs, a candidate relay UE with the highest PC5 signal strength as the determined relay UE in response to determining that the relay option of the UE indicates that both L2 relaying and L3 relaying are supported. In some embodiments, the step of determining at least one of the one or more candidate relay UEs as the determined relay UE comprises: determining a candidate relay UE, which is first discovered to support L2 relaying, as the determined relay UE in response to determining that the relay option of the UE indicates that L2 relaying is prioritized over L3 relaying and determining that at least one candidate relay UE supporting at least L2 relaying is discovered; determining a candidate relay UE, which supports only L3 relaying, as the determined relay UE in response to determining that the relay option of the UE indicates that L2 relaying is prioritized over L3 relaying and determining that no candidate relay UE supporting L2 relaying is discovered; determining a candidate relay UE, which is first discovered to support at least L3 relaying, as the determined relay UE in response to determining that the relay option of the UE indicates that L3 relaying is prioritized over L2 relaying and determining that at least one candidate relay UE supporting at least L3 relaying is discovered; and determining a candidate relay UE, which supports only L2 relaying, as the determined relay UE in response to determining that the relay option of the UE indicates that L3 relaying is prioritized over L2 relaying and determining that no candidate relay UE supporting L3 relaying is discovered. In some embodiments, the step of determining at least one of the one or more candidate relay UEs as the determined relay UE comprises: determining a signal strength offset for each candidate relay UE at least partially based on the indication received from the corresponding candidate relay UE; and determining, from the one or more candidate relay UEs, a candidate relay UE with the greatest sum of the measured signal strength and the corresponding signal strength offset as the determined relay UE. In some embodiments, the step of determining a signal strength offset for each candidate relay UE at least partially based on the indication received from the corresponding candidate relay UE comprises at least one of: determining the signal strength offset as a positive value in response to determining that the relay option indicated by the candidate relay UE is compatible with and prioritized by the relay option of the UE; and determining the signal strength offset as a negative value in response to determining that the relay option indicated by the candidate relay UE is not compatible with or the relay option indicated by the candidate relay UE is not prioritized by the relay option of the UE.

In some embodiments, the step of determining zero or at least one relay UE at least partially based on the determined relay option comprises determining the zero or at least one relay UE further based on one or more of following criteria: —a Quality of Service (QOS) requirement of a service or flow which needs to be relayed; —load of the serving cell of a candidate relay UE; —load of a candidate relay UE; and—an access restriction on a cell of interest. In some embodiments, the step of determining zero or at least one relay UE at least partially based on the determined relay option comprises determining the zero or at least one relay UE by at least one of: prioritizing a candidate relay UE supporting L2 relaying over a candidate relay UE supporting L3 relaying in response to determining that the QoS requirement indicates a stricter requirement; prioritizing a candidate relay UE supporting L3 relaying over a candidate relay UE supporting L2 relaying in response to determining that the QoS requirement indicates a less strict requirement; prioritizing a candidate relay UE supporting L2 relaying over a candidate relay UE supporting L3 relaying in response to determining that the QoS requirement indicates a stronger service continuity; prioritizing a candidate relay UE supporting L3 relaying over a candidate relay UE supporting L2 relaying in response to determining that the QoS requirement indicates a weaker service continuity; prioritizing a candidate relay UE supporting L2 relaying over a candidate relay UE supporting L3 relaying in response to determining that the cell has a low or medium cell load; prioritizing a candidate relay UE supporting L3 relaying over a candidate relay UE supporting L2 relaying in response to determining that the cell has a high cell load; prioritizing a candidate relay UE supporting L2 relaying over a candidate relay UE supporting L3 relaying in response to determining that the cell has a less strict access restriction; and prioritizing a candidate relay UE supporting L3 relaying over a candidate relay UE supporting L2 relaying in response to determining that the cell has a stricter access restriction.

In some embodiments, the method further comprises: transmitting, to the network node, a report message indicating that there is no relay UE supporting the determined relay option for the sidelink in response to determining so. In some embodiments, the report message comprises at least one of: —a failure cause; —the determined relay option; and—one or more discovery models used for discovering relay UE. In some embodiments, the report message is transmitted to the network node via at least one of: —RRC signaling; and—MAC CE. In some embodiments, the step of transmitting, to the network node, a report message comprises one of: transmitting, to the network node, the report message directly; and transmitting, to the network node, the report message indirectly via a relay UE with a different relay option than the determined relay option.

In some embodiments, the method further comprises: determining an updated relay option at least partially based on the UE's updated configuration and/or an updated indication received from the network node or another UE; keeping communicating with the current serving relay UE for sidelink communication in response to determining that the current serving relay UE supports the updated relay option. In some embodiments, the method further comprises: communicating with a first relay UE supporting a first relay option for a first service or flow and with a second relay UE supporting a second relay option for a second service or flow, wherein the first relay option is different from the second relay option, wherein the first service or flow is different from the second service or flow. In some embodiments, the first relay UE and the second relay UE are served by a same network node or different network nodes.

In some embodiments, the method further comprises: selecting a candidate relay UE which supports a different relay option than that of the current serving relay UE as the reselected relay UE in response to determining at least one of the following conditions is met: —a QoS requirement of a service or flow which is being relayed by the current serving relay UE cannot be fulfilled; —a PC5 signal strength of the link between the UE and the current serving relay UE is below a configured threshold; —a Uu signal strength of the link between the current serving relay UE and its serving network node is below a configured threshold; —a PC5 load of the link between the UE and the current serving relay UE is above a configured threshold; —a load of the serving cell of the current serving relay UE is above a configured threshold; and—a preference policy of relay option is updated. In some embodiments, the step of determining that a condition is met comprises: determining that the condition is met for a configured time threshold. In some embodiments, the reselected relay UE is the current serving relay UE supporting a relay option which is compatible with the different relay option. In some embodiments, the step of selecting a candidate relay UE which supports a different relay option than that of the current serving relay UE as a new relay UE comprises: selecting a candidate relay UE which supports a different relay option than that of the current serving relay UE and which meets at least one of conditions in a better manner than the current serving relay UE, as the reselected relay UE.

According to a second aspect of the present disclosure, a UE is provided. The UE comprises: a processor; a memory storing instructions which, when executed by the processor, cause the processor to perform any of the methods of the first aspect.

According to a third aspect of the present disclosure, a method at a relay user equipment (UE) for facilitating a first UE in communicating with a network node is provided. In some embodiments, the communication is relayed over a sidelink. The method comprises: determining a relay option at least partially based on the relay UE's configuration and/or an indication received from the network node or another UE; communicating with the first UE to attempt establishing the sidelink for the first UE at least partially based on the determined relay option.

In some embodiments, the relay option comprises one of: —L2 relaying is supported; —L3 relaying is supported; and—both L2 relaying and L3 relaying are supported. In some embodiments, the relay UE's configuration comprises its relaying capability and/or relaying preference. In some embodiments, the step of determining a relay option at least partially based on the relay UE's configuration and/or an indication received from the network node or another UE comprises: determining the relay option based on the indication received from the network node or the other UE in response to determining that the relay UE's configuration is different from the indication received from the network node or the other UE. In some embodiments, the relay UE's configuration is configured and/or preconfigured in Mobile Equipment (ME) or Universal Integrated Circuit Card (UICC) of the UE. In some embodiments, the indication is received from the network node or the other UE via broadcasted system information, dedicated Radio Resource Control (RRC) signaling, and/or a Medium Access Control (MAC) Control Element (CE). In some embodiments, the step of communicating with the first UE to attempt establishing the sidelink for the first UE at least partially based on the determined relay option comprises: broadcasting or transmitting, to the first UE, a discovery message indicating the determined relay option; and receiving, from the first UE, an indication indicating that the determined relay option is supported; and relaying data between the first UE and the network node for sidelink communication.

In some embodiments, the step of communicating with the first UE to attempt establishing the sidelink for the first UE at least partially based on the determined relay option comprises: receiving, from the first UE, a discovery message comprising an indication indicating its relay option; determining whether the first UE can be served or not for sidelink communication at least partially based on the determined relay option and the received indication; and relaying data between the first UE and the network node for sidelink communication in response to determining that the first UE can be served for sidelink communication. In some embodiments, the received indication indicates that a relay option of the first relay UE is supported by its serving or camping network node. In some embodiments, the method further comprises: receiving, from the network node, a signal strength offset for the relay UE; determining the sum of a measured signal strength for the first UE and/or the network node and the signal strength offset; and transmitting, to the first UE and/or the network node, the determined sum. In some embodiments, the signal strength offset is a positive value in response to determining that the determined relay option is compatible with and prioritized by the relay option of the network node, wherein the signal strength offset is a negative value in response to determining that the determined relay option is not compatible with or the determined relay option is not prioritized by the relay option of the network node.

In some embodiments, the method further comprises: receiving, from the first UE, a report message indicating that there is no relay UE supporting its desired relay option for the sidelink; and transmitting, to the network node, the report message or another report message, which is generated based on the report message, indicating that there is no relay UE supporting the first UE's desired relay option. In some embodiments, any of the report messages comprises at least one of: —a failure cause; —the determined relay option; and—one or more discovery models used for discovering relay UE. In some embodiments, the report message is received from the first UE and/or transmitted to the network node via at least one of: —RRC signaling; and—MAC CE.

In some embodiments, the method further comprises: determining an updated relay option at least partially based on the relay UE's updated configuration and/or an updated indication received from the network node or another UE; keeping communicating with the first UE for sidelink communication in response to determining that the first UE supports the updated relay option.

According to a fourth aspect of the present disclosure, a relay UE is provided. The relay UE comprises: a processor; a memory storing instructions which, when executed by the processor, cause the processor to perform any of the methods of the third aspect.

According to a fifth aspect of the present disclosure, a method at a network node for communicating with a first UE is provided. In some embodiments, the communication is relayed over a sidelink. The method comprises: determining a relay option at least partially based on the network node's configuration and/or an indication from another node; communicating with the first UE and/or one or more relay UEs to attempt establishing the sidelink for the first UE at least partially based on the determined relay option.

In some embodiments, the relay option comprises one of: —L2 relaying is supported; —L3 relaying is supported; and—both L2 relaying and L3 relaying are supported. In some embodiments, the network node's configuration comprises its relaying capability and/or relaying preference. In some embodiments, the step of determining the relay option comprises at least one of: determining the relay option as being compatible with “L3 relaying is supported” in response to determining that the network node has signaled its discovery configuration for L3 relaying to UEs in its coverage; and determining the relay option as being compatible with “L3 relaying is supported” in response to determining that the network node has signaled an indication indicating its support of L3 relaying to UEs in its coverage. In some embodiments, the indication further indicates one or more conditions under which L3 relaying is supported.

In some embodiments, the step of determining the relay option comprises at least one of: determining the relay option as being compatible with “L2 relaying is supported” in response to determining that the network node has signaled its discovery configuration for L2 relaying to UEs in its coverage; and determining the relay option as being compatible with “L2 relaying is supported” in response to determining that the network node has signaled an indication indicating its support of L2 relaying to UEs in its coverage. In some embodiments, the indication further indicates one or more conditions under which L2 relaying is supported. In some embodiments, the discovery configuration comprises at least one of: —discovery resources; —discovery measurement gap; —PC5 Reference Signal Received Power (RSRP) threshold for triggering relay reselection. In some embodiments, the discovery configuration comprises an L2 relay specific discovery configuration and/or an L3 relay specific discovery configuration.

In some embodiments, the method further comprises: transmitting or broadcasting, to the first UE and/or one or more relay UEs, one or more of: —the network node's capability in supporting both L2 and L3 relaying, —the network node's preference on whether L2 or L3 relaying is prioritized; and—one or more conditions under which L2 and/or L3 relaying are supported. In some embodiments, the method further comprises: determining an updated relay option at least partially based on the network node's updated configuration and/or an updated indication from another node; communicating with the first UE and/or one or more relay UEs to attempt establishing the sidelink for the first UE at least partially based on the updated relay option.

In some embodiments, the method further comprises: transmitting, to another network node, its determined relay option and/or discovery configuration for sidelink communication. In some embodiments, the step of communicating with the first UE and/or one or more relay UEs to attempt establishing the sidelink for the first UE at least partially based on the determined relay option comprises: preventing the determined relay option and/or the discovery configuration from being transmitted or broadcasted to the first UE and/or any relay UE. In some embodiments, the step of communicating with the first UE and/or one or more relay UEs to attempt establishing the sidelink for the first UE at least partially based on the determined relay option further comprises: receiving, from the first UE or a relay UE with a relay option not supported and/or prioritized, a connection setup request; and transmitting, to the first UE or the relay UE, a rejection message indicating a rejection to the connection setup request. In some embodiments, the rejection message comprises at least one of: —a rejection reason; —one or more suggested network nodes that the first UE or the relay UE can access; and—one or more configurations of the one or more suggested network nodes that the first UE or the relay UE can access.

In some embodiments, the method further comprises: transmitting, to a target network node, a relay UE's relay option and/or discovery configurations as a part of the relay UE's context in response to determining that the relay UE is to be handed over to the target network node; and/or transmitting, to a relay UE, a target network node's relay option and/or discovery configurations as a part of a handover command in response to determining that the relay UE is to be handed over to the target network node.

In some embodiments, the method further comprises: receiving, from a target network node, a relay UE's relay option and/or discovery configurations as a part of the relay UE's context; and determining whether the relay UE is accepted at least partially based on the received relay option and/or discovery configurations. In some embodiments, the indication and/or discovery configuration of the network node is determined at the first UE via at least one of: —broadcasted system information; —dedicated RRC signaling; —a MAC CE; —a paging message; —a control packet data unit (PDU) from a protocol layer; —an L1 signaling; and—a pre-configured or hard-coded configuration at the first UE. In some embodiments, the indication and/or discovery configuration is transmitted from the network node to the first UE via a relay UE via an RRC message. In some embodiments, at least a part of the relay option and/or discovery configurations of the network node, the first UE, and/or one or more relay UEs is signaled from a core network node. In some embodiments, the method further comprises, for each of one or more relay UE: determining a signal strength offset for the relay UE at least partially based on an indication received from the relay UE; transmitting, to the relay UE, the determined signal strength offset; receiving, from the relay UE, a sum of its measured signal strength and the signal strength offset; and determining whether the first UE can be served by the relay UE for sidelink communication or not. In some embodiments, the step of determining a signal strength offset for the relay UE at least partially based on an indication received from the relay UE comprises at least one of: determining the signal strength offset as a positive value in response to determining that the relay option indicated by the relay UE is compatible with and prioritized by the relay capability and/or relay preference of the network node; and determining the signal strength offset as a negative value in response to determining that the relay option indicated by the relay UE is not compatible with or the relay option indicated by the relay UE is not prioritized by the relay capability and/or relay preference of the network node.

According to a sixth aspect of the present disclosure, a network node is provided. The network node comprises: a processor; a memory storing instructions which, when executed by the processor, cause the processor to perform any of the methods of the fifth aspect.

According to a seventh aspect of the present disclosure, a computer program comprising instructions is provided. The instructions, when executed by at least one processor, cause the at least one processor to carry out the method of any of the first, third, and/or fifth aspects.

According to an eighth aspect of the present disclosure, a carrier containing the computer program of the seventh aspect is provided. In some embodiments, the carrier is one of an electronic signal, optical signal, radio signal, or computer readable storage medium.

According to a ninth aspect of the present disclosure, a telecommunications system is provided. The telecommunication system comprises: one or more UEs of the second aspect; one or more relay UEs of the fourth aspect; and at least one network node of the sixth aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunications network in which relay selection for transmission over sidelink according to an embodiment of the present disclosure may be applicable.

FIG. 2A is a diagram illustrating an architecture model using a layer 3 (L3) UE-to-Network relay in which communication over sidelink according to an embodiment of the present disclosure may be applicable.

FIG. 2B is a diagram illustrating an exemplary protocol stack for an architecture model using a layer 3 (L3) UE-to-Network relay in which communication over sidelink according to an embodiment of the present disclosure may be applicable.

FIG. 3A and FIG. 3B are diagrams illustrating exemplary User Plane (UP) and Control Plane (CP) protocol stacks for an architecture model using a layer 2 (L2) UE-to-Network relay, respectively, in which communication over sidelink according to an embodiment of the present disclosure may be applicable.

FIG. 4 is a flow chart of an exemplary method at a remote UE for communicating with a network node over a sidelink according to an embodiment of the present disclosure.

FIG. 5 is a flow chart of an exemplary method at a relay UE for facilitating a first UE in communicating with a network node over a sidelink according to an embodiment of the present disclosure.

FIG. 6 is a flow chart of an exemplary method at a network node for communicating with a first UE over a sidelink according to an embodiment of the present disclosure.

FIG. 7 schematically shows an embodiment of an arrangement which may be used in a remote UE, a relay UE, and/or a network node according to an embodiment of the present disclosure.

FIG. 8 is a block diagram of an exemplary UE according to an embodiment of the present disclosure.

FIG. 9 is a block diagram of an exemplary relay UE according to an embodiment of the present disclosure.

FIG. 10 is a block diagram of an exemplary network node according to an embodiment of the present disclosure.

FIG. 11 schematically illustrates a telecommunication network connected via an intermediate network to a host computer according to an embodiment of the present disclosure.

FIG. 12 is a generalized block diagram of a host computer communicating via a base station with a user equipment over a partially wireless connection according to an embodiment of the present disclosure.

FIG. 13 to FIG. 16 are flowcharts illustrating methods implemented in a communication system including a host computer, a base station and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5th Generation New Radio (5G NR), the present disclosure is not limited thereto. In fact, as long as sidelink communication is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “network node” used herein may refer to a base station, a base transceiver station, an access point, a hot spot, a NodeB (NB), an evolved NodeB (eNB), a gNB, a network element, an access network (AN) node, or any other equivalents. Further, the term “node” used herein may refer to a UE, a functional entity, a network entity, a network element, a network equipment, or any other equivalents. Further, following 3GPP documents are incorporated herein by reference in their entireties:
3GPP TR 23.752 V2.0.0 (2021-03), Technical Report, 3rd Generation Partnership Project; Technical Specification Group Services and System Aspects; Study on system enhancement for Proximity based Services (ProSe) in the 5G System (5GS) (Release 17).

Before some embodiments of the present disclosure are described, a brief introduction of sidelink will be given below.

Similar to Long Term Evolution (LTE), NR uses the OFDM (Orthogonal Frequency Division Multiplexing) technology in the downlink (i.e. from a network node, gNB, eNB, or base station to a user equipment or UE). The basic NR physical resource over an antenna port can thus be seen as a time-frequency grid, where a resource block (RB) in a 14-symbol slot is used. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ∈{0,1,2,3,4}. Δf=15 kHz is the basic (or reference) subcarrier spacing that is also used in LTE.

In the time domain, downlink and uplink transmissions in NR will be organized into equally-sized subframes of 1 ms each, similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz and a slot consists of 14 OFDM symbols as mentioned above.

Downlink transmissions are dynamically scheduled, i.e., in each slot the gNB may transmit downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Downlink Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH.

In addition to PDCCH and PDSCH, there are also other channels and reference signals transmitted in the downlink, including Synchronous Signal and PBCH Block (SSB), Channel State Information-Reference Signal (CSI-RS), etc.

Uplink data transmissions, carried on Physical Uplink Shared Channel (PUSCH), can also be dynamically scheduled by the gNB by transmitting a DCI. The DCI (which is transmitted in the DL region) always indicates a scheduling time offset so that the PUSCH is transmitted in a slot in the UL region.

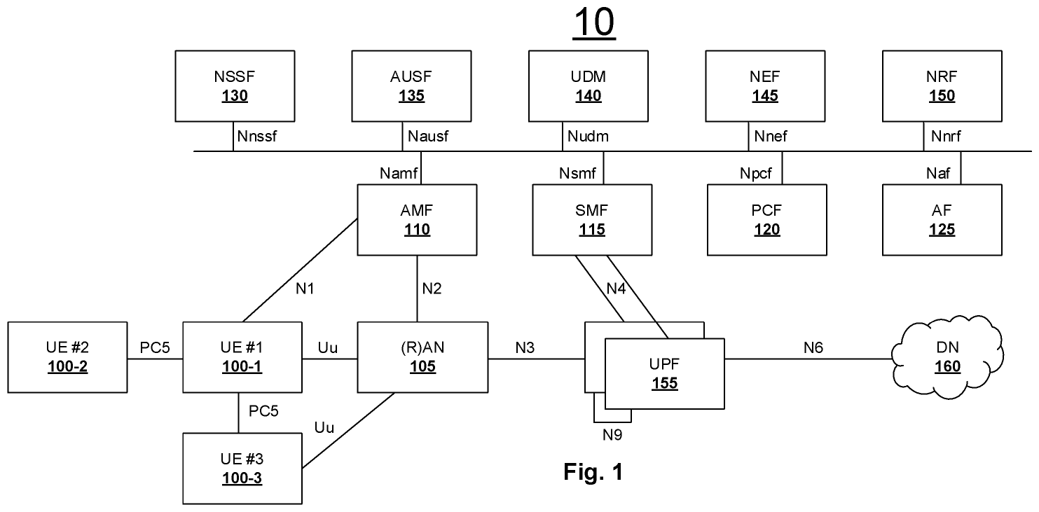

FIG. 1 is a diagram illustrating an exemplary telecommunications network 10 in which communication over sidelink according to an embodiment of the present disclosure may be applicable. Although the telecommunications network 10 is a network defined in the context of 5G NR, the present disclosure is not limited thereto.

As shown in FIG. 1, the network 10 may comprise one or more UEs 100-1, 100-2, and 100-3 (collectively, UE(s) 100) and a (radio) access network ((R)AN) 105, which could be a base station, a Node B, an evolved NodeB (eNB), a gNB, or an AN node which provides the UEs 100 with access to other parts of the network 10. Further, the network 10 may comprise its core network portion comprising (but not limited to) an Access and Mobility Management Function (AMF) 110, a Session Management Function (SMF) 115, a Policy Control Function (PCF) 120, an Application Function (AF) 125, a Network Slice Selection Function (NSSF) 130, an Authentication Server Function (AUSF) 135, a Unified Data Management (UDM) 140, a Network Exposure Function (NEF) 145, a Network Repository Function (NRF) 150, and one or more User Plane Functions (UPFs) 155. As shown in FIG. 1, these entities may communicate with each other via the service-based interfaces, such as, Namf, Nsmf, Npcf, etc. and/or the reference points, such as, N1, N2, N3, N6, N9, etc. Further, as shown in FIG. 1, the UEs 100 may communicate with each other via sidelinks over the reference point PC5.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

For the sidelink transmissions over PC5 shown in FIG. 1, they are specified for 3GPP Rel. 16. These are enhancements of the ProSe (proximity-based services) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the QoS management is supported in NR sidelink transmissions.

To enable the above enhancements, new physical channels and reference signals are introduced in NR (available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink Feedback Channel): The PSFCH is transmitted by a sidelink receiver UE for unicast and groupcast, which conveys 1 bit information over 1 RB for the hybrid automatic repeat request (HARQ) acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, the transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitting the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (e.g., UE/eNB/gNB) sending the S-PSS/S-SSS is called a synchronization source. In some embodiments, there are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. In some embodiments, the SSB may be transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. In some embodiments, the PT-RS may be only applicable for FR2 (frequency range 2) transmission.

Another new feature is the two-stage sidelink control information (SCI). This is a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for PROSE in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:
Dynamic grant: When the traffic to be sent over sidelink arrives at a transmitter UE, this UE should launch the four-message exchange procedure to request sidelink resources from a gNB (that is, SR (scheduling request) on UL, grant, BSR (buffer state report) on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB (transport block). As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC (cyclic redundancy check) is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

There are device-to-device (D2D) discovery procedures for detection of services and applications offered by other UEs in close proximity. This discovery procedure is a part of LTE Rel 12 and Rel 13. The discovery procedure has two modes, mode A based on open announcements (broadcasts) and mode B, which is based on request/response mechanism. The discovery mechanism is controlled by the application layer (ProSe). The discovery message is sent on the Physical Sidelink Discovery Channel (PSDCH) which is not available in NR. Also, there is a specific resource pool for announcement and monitoring of discovery messages. The discovery procedure can be used to detect UEs supporting certain services or applications before initiating direct communication.

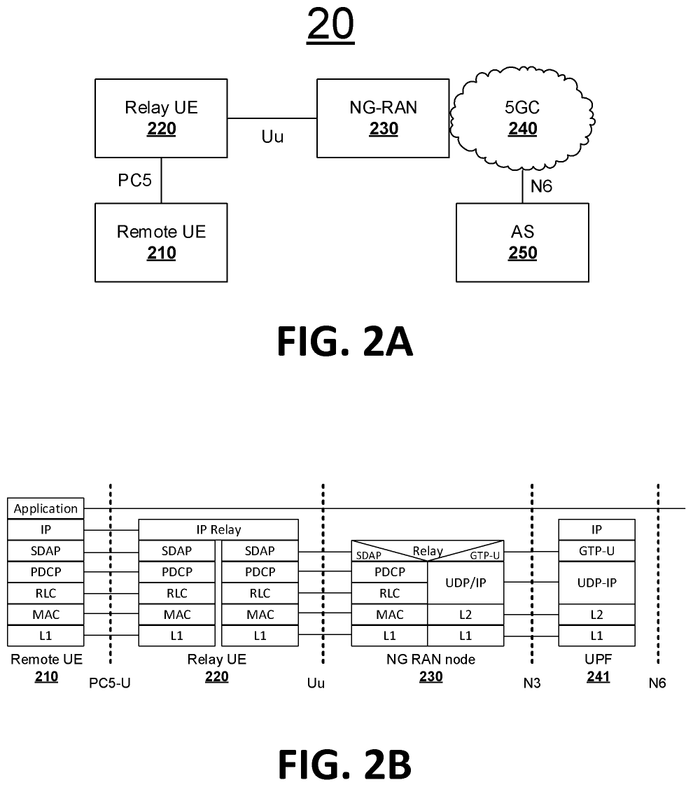

In the 3GPP TR 23.752 clause 6.6, a layer-3 based UE-to-Network relay is described. FIG. 2A is a diagram illustrating an architecture model 20 using a layer 3 (L3) UE-to-Network relay 220 in which communication over sidelink according to an embodiment of the present disclosure may be applicable. As shown in FIG. 2A, the architecture model 20 may comprise a remote UE 210, a relay UE 220, an NG-RAN node 230, a 5G core network (5GC) 240, and an application server (AS) 250. The remote UE 210 may communicate with the relay UE 220 via the reference point PC5, the relay UE 220 may communicate with the NG-RAN node 230 via the reference point Uu, and the 5GC 240 may communicate with the AS 250 via the reference point N6. However, the present disclosure is not limited thereto.

The ProSe 5G UE-to-Network Relay entity (e.g., the relay UE 220 shown in FIG. 2A) provides the functionality to support connectivity to the network for Remote UEs (e.g. the remote UE 210 shown in FIG. 2A). It can be used for both public safety services and commercial services (e.g. interactive service). A UE is considered to be a Remote UE for a certain ProSe UE-to-Network relay if it has successfully established a PC5 link to this ProSe 5G UE-to-Network Relay. A Remote UE can be located within NG-RAN coverage (in-coverage) or outside of NG-RAN coverage (out-of-coverage).

The relay UE 220 shall relay unicast traffic (UL and DL) between the remote UE 210 and the network (e.g. the NG-RAN node 230, the AS 250, etc.). The relay UE 220 shall provide generic function that can relay any IP traffic. Further, one-to-one Direct Communication is used between Remote UEs (e.g., the remote UE 210) and ProSe 5G UE-to-Network Relays (e.g., the relay UE 220) for unicast traffic as specified in solutions for Key Issue #2 in the 3GPP TR 23.752.

FIG. 2B is a diagram illustrating an exemplary protocol stack for the architecture model 20 shown in FIG. 2A. Hop-by-hop security is supported in the PC5 link and Uu link. If there are requirements beyond hop-by-hop security for protection of remote UE 210's traffic, security over IP layer needs to be applied.

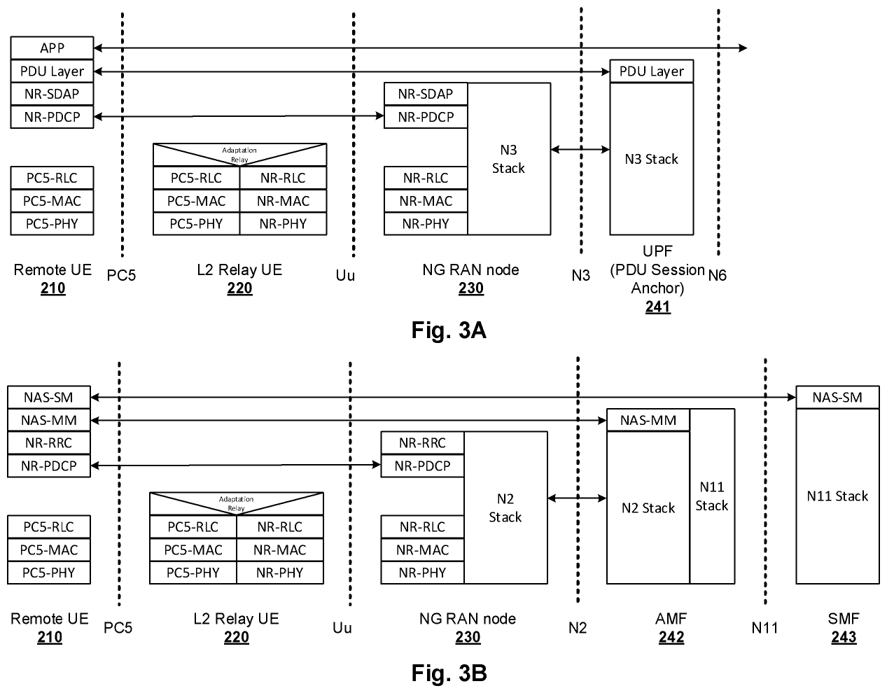

In the TR 23.752 clause 6.7, a layer-2 based UE-to-Network relay is described. The architecture model using a layer-2 based relay is similar to that shown in FIG. 2A, and therefore the detailed description thereof is omitted for simplicity. Next, a detailed description of the control plane and user plane protocol stacks for supporting Layer 2 relay UE will be given with reference to FIG. 3A and FIG. 3B. An L2 UE-to-Network Relay UE may provide forwarding functionality that can relay any type of traffic over the PC5 link. An L2 UE-to-Network Relay UE may provide the functionality to support connectivity to the 5GS for Remote UEs. A UE may be considered to be a Remote UE if it has successfully established a PC5 link to the L2 UE-to-Network Relay UE. A Remote UE may be located within NG-RAN coverage or outside of NG-RAN coverage.

FIG. 3A and FIG. 3B are diagrams illustrating exemplary User Plane (UP) and Control Plane (CP) protocol stacks for an architecture model using a layer 2 (L2) UE-to-Network relay, respectively, in which communication over sidelink according to an embodiment of the present disclosure may be applicable.

FIG. 3A illustrates the protocol stack for the user plane transport, related to a PDU Session, including a layer 2 relay UE 220. The PDU layer corresponds to the PDU carried between the remote UE 210 and the Data Network (DN) over the PDU session. The SDAP and PDCP protocols are as specified in TS 38.300. It is important to note that the two endpoints of the PDCP link are the remote UE 210 and the NG RAN node 230. The relay function is performed below PDCP. This means that data security is ensured between the remote UE 210 and the NG RAN node 230 without exposing raw data at the relay UE 220.

The adaptation relay layer within the relay UE 220 can differentiate between signalling radio bearers (SRBs) and data radio bearers (DRBs) for a particular remote UE 210. The adaption relay layer may also be responsible for mapping PC5 traffic to one or more DRBs of the Uu.

FIG. 3B illustrates the protocol stack of the NAS connection for the remote UE 210 to the NAS-MM and NAS-SM components. The NAS messages are transparently transferred between the remote UE 210 and the NG RAN node 230 over the layer 2 relay UE 220 using:
PDCP end-to-end connection where the role of the relay UE 220 is to relay the PDUs over the signalling radio bear without any modifications.
N2 connection between the NG RAN node 230 and AMF 242 over N2.
N11 connection AMF 242 and SMF 243 over N11.

The role of the relay UE 220 is to relay the PDUs from the signalling radio bearer without any modifications.

In the 3GPP WID on SL relay, the objective of this work item is to specify solutions to enable single-hop, sidelink-based, L2 and L3 based UE-to-Network (U2N) relaying.

Work Item objectives on aspects common to both L2 and L3:
1. Specify mechanisms for U2N relay discovery and (re)selection for L3 and L2 relaying [RAN2, RAN4]
   a. Re-use LTE relay discovery and (re)selection as baseline
2. Specify mechanisms for Relay and Remote UE authorization for L3 and L2 relaying [RAN3]
   a. Re-use LTE as baseline

Some embodiments of the present disclosure are related to how to handle coexistence of L2 relaying and L3 relaying at UE and gNB. In typical cases, a UE or a gNB/cell can be configured or preconfigured with a single relaying option (either L2 relaying or L3 relaying). Corresponding UE capabilities for indicating the relay option are defined accordingly.

The gNB may be determined as L3/L2 relaying capable if at least one of the below conditions is met:
the gNB has signaled discovery configuration (e.g., discovery resources, discovery measurement gap, PC5 RSRP threshold for triggering relay reselection) to UEs in the cell.
the gNB has signaled indicators which explicitly or implicitly indicate that the gNB is capable of L3 relaying operation. In addition, the gNB may signal in which conditions L3/L2 relaying operation is supported.

For a UE supporting both L2 relaying option and L3 relaying option, the UE may determine which relay option shall be applied according to different criteria.

In some embodiments, a remote UE and/or relay UE may indicate the relay option, i.e. L2 relay, L3 relay, or both L2 and L3 relay, that it supports or prioritizes in e.g. discovery message. In some embodiments, a remote UE may be configured/preconfigured with a precedence between L2 relaying and L3 relaying and performs relay UE (re)selection based on this precedence. In some embodiments, criteria for adopting L2 relay or L3 relay are proposed. In some embodiments, a failure report to the network (NW) indicates that relay (re)selection is failed due to relay UE with the same supported relay option cannot be found. In some embodiments, gNB may indicate the supported/prioritized relay option and the corresponding conditions (i.e. under which conditions the relay option is supported/prioritized). In some embodiments, gNB may inform discovery configuration used for certain relay option. In some embodiments, inter-gNB signalling on SL relay capability/configuration is proposed.

In some embodiments, two or more SL UEs may be deployed in a same or different NR cells. However, the same principle may be applied to LTE or any other technology that enables the direct connection of two (or more) nearby devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

Herein, the terms “direct connection” or “direct path” may stand for a connection between a UE and a gNB, while the terms “indirect connection” or “indirect path” may stand for a connection between a remote UE and gNB via a relay UE. In addition, the term “path switch” refers to a remote UE which changes between a direct path (i.e., Uu connection) and an indirect path (i.e., relay connection via a SL relay UE). The other term such as “relay selection/reselection” may be equally applicable here without losing any meaning.

The embodiments are applicable to both L2 based U2N relay scenarios and L3 based U2N relay scenarios. However, the present disclosure is not limited to U2N relay scenarios, and they are also applicable to U2U relay scenarios.

Some embodiments of the present disclosure are described below with respect to UE actions on handling coexistence of L2 relaying and L3 relaying.

In some embodiments, an SL capable UE may be configured to support one of the following relaying options
L2 relaying
L3 relaying
Both L2 relaying and L3 relaying

In some embodiments, a relay option may be configured/preconfigured to the UE as a UE capability, e.g. in ME or UICC. In some embodiments, a relay option may be configured to the UE via system information, dedicated RRC signaling or MAC CE by a gNB or a controlling UE.

In some embodiments, whenever a remote UE is triggered to perform relay selection or reelection, the relay option (e.g., one of the options as described in the above embodiment) that the remote UE supports may be included in every discovery message upon which the UE can exchange the information of the relay option with neighbor UEs, such that the remote UE can thereby (re)select a candidate relay UE being able to support the same relay option as the relay UE.

In some embodiments, a UE who is capable of a relay UE may include its relay option in every discovery message that the UE transmits in its proximity so that the UE may exchange the information of the relay option with neighbor UEs. A remote UE may therefore (re)select this UE as a relay UE if they are able to support the same relay option.

In some embodiments, the relay UE may indicate a certain relay option if the option is supported by both the relay UE and its serving/camping gNB.

In some embodiments, for a remote UE supporting or configured with the relay option, i.e., both L2 relaying and L3 relaying, during a relay selection/reselection procedure, the remote UE may receive discovery messages from multiple relay UE candidates, the remote UE may thereby select a candidate UE as the relay UE e.g., which gives the strongest PC5 signal strength towards the remote UE. In some embodiments, this selected relay UE may be L2 relay capable or L3 relay capable or both.

In some embodiments, the remote UE may be configured/preconfigured with a precedence between L2 relaying and L3 relaying. In some embodiments, the remote UE may first attempt to find a relay UE according to the prioritized relay option. If the relay UE with the prioritized relay option can be found, the remote UE may stop searching further relay UE candidates with the other relay option. Otherwise, if the relay UE with the prioritized relay option cannot be found (e.g., within a configured time period), the remote UE may search relay UE candidates with the other relay option and thereby may find a suitable relay UE.

In some embodiments, a gNB may control the remote UE to do the relay selection via common or dedicated control signaling (i.e. select L2 or L3 relay or which relay option is prioritized). In some embodiments, the common control signaling may be forwarded by the relay UE using e.g. PC5-RRC.

In some embodiments, an offset may be (pre)configured to the remote UE so that the remote UE can add the offset to discovery signal strength results measured by the remote UE during relay selection/reselection procedure. In this way, the remote UE can select a relay UE candidate mapping to the prioritized relay option. In an example, if remote UE prioritizes a relay option (e.g., L2 relaying), the remote UE may add a positive offset to measured discovery signal strength (e.g., RSRP) results received from relay UEs with L2 relaying capable, thus the remote UE may most likely select a L2 relaying capable relay UE. In another example, if remote UE prioritizes a relay option (e.g., L2 relaying), the remote UE may add a negative offset to measured discovery signal strength (e.g., RSRP) results received from relay UEs with L3 relaying capable, thus the remote UE may most likely select a L2 relaying capable relay UE.

Similarly, in some embodiments, if the relay UE needs to send its measurement results of radio quality (e.g., RSRP) on PC5 interfaces or Uu links to other UEs or gNBs, the relay UE may add an offset value to measurement results, which may assist the other UEs or gNBs to select this relay UE as the relay UE. Such option can be applicable in case the relay UE is capable of the relay option which needs to be prioritized or down-prioritized. In an example, the relay UE may add a positive offset to the measurement results, which may be sent to other UEs or gNBs in case the relay UE is capable of the relay option which needs to be prioritized. In another example, the relay UE may add a negative offset to the measurement results, which may be sent to other UEs or gNBs in case the relay UE is capable of the relay option which needs to be down-prioritized.

In some embodiments, for a remote UE supporting or configured with the relay option, i.e., both L2 relaying and L3 relaying, during a relay selection/reselection procedure, the remote UE may determine or be instructed to use one of the both relay options, i.e., L2 relaying or L3 relaying based on at least one of the following criteria
QoS requirements of services or flows which need to be relayed;
Load of the serving cell of candidate relay UE (e.g., indicated or carried by discovery message sent by the relay UE candidate);
Load of the candidate relay UE (e.g., indicated or carried by discovery message sent by the relay UE candidate);
Access restrictions on the cell (e.g., admission control parameters including Access Identities or Access Categories or Access classes).

In some embodiments, with L2 relaying, unlike L3 relaying, the remote UE may be visible to the gNB (i.e., there is the corresponding UE context at the gNB) so that the gNB is able to control the remote UE. The remote UE may be served with better E2E QoS treatment than with L3 relaying. In addition, in some embodiments, the remote UE with L2 relaying may perform path switch by reusing existing Uu handover mechanism to reduce potential interruption due to path switch. In this way, service continuity may be better guaranteed than with L3 relaying.

For services or flows requiring strict QoS requirements for example, short latency, low packet loss, low jitter, the remote UE may determine or be instructed to apply L2 relaying.

In some embodiments, for services or flows requiring less strict QoS requirements, the remote UE may determine or be instructed to apply L3 relaying. In some embodiments, for services or flows requiring strong service continuity, the remote UE may determine or be instructed to apply L2 relaying. In some embodiments, for services or flows requiring less strong service continuity, the remote UE may determine or be instructed to apply L3 relaying. In some embodiments, for a cell with high cell load (e.g., the number of served UE contexts), the remote UE may determine or be instructed to connect to the cell via a relay UE based on L3 relaying. In some embodiments, for a cell with low or medium cell load (e.g., the number of served UE contexts), the remote UE may determine or be instructed to connect to the cell via a relay UE based on L2 relaying. In some embodiments, for a cell with strict access restrictions (e.g., only allowing UEs associated with specific Access Identities or Access Categories or Access classes to access the cell), the remote UE may determine or be instructed to connect to the cell via a relay UE based on L3 relaying.

In some embodiments, when the remote UE determines or is instructed to use a relay option while the relay UE(s) supporting that the relay option cannot be found by the remote UE, the remote UE sends a report message to the NW, which carries at least one of the following information:
Failure cause (e.g., no relay UE candidate found according to the determined or instructed relay option)
The determined or instructed relay option
Discovery models (i.e., Model A or B) which have been used for transmission of discovery messages.

The report message may be signaled to the NW by the remote UE via at least one of the following signaling alternatives
RRC signaling (e.g., Uu RRC or PC5-RRC)
MAC CE

In some embodiments, the remote UE may send the report message directly to the network (e.g., gNB) or via a relay UE. For the latter, the remote UE may send the report message via another relay UE after the remote UE has found the other relay UE according to a different relay option from the instructed one. Note that changing of relay option may or may not lead to relay reselection. When the relay UE (and the remote UE) are capable of both L2 relay and L3 relay, the remote UE may change relay option w/o changing relay UE. The above described criteria on selection of the relay option is also applicable to any relay UE whenever the relay UE needs to select a relay option.

In some embodiments, a remote UE may connect to multiple relay UEs at the same time, wherein at least one relay UE may be based on L2 relaying and at least one relay UE may be based on L3 relaying. In this case, the remote UE may have different services or flows being relayed via these relay UEs to the same or different gNBs.

In some embodiments, a remote UE (e.g., UE A) connecting to a serving relay UE (e.g., UE B) may determine or be instructed to select a different or same relay UE (e.g., UE C) which may support a different relaying option compared to its serving relay UE (e.g., UE B). In some embodiments, UE B and C may be the same UE. In an example, UE B may support L3 relaying while UE C may support L2 relaying. In another example, UE B may support L2 relaying while UE C may support L3 relaying. This relay UE reselection may be triggered when at least one of the following conditions is met:
Services or flows which are being relayed by the serving relay UE cannot fulfil certain QoS requirements (e.g., latency, packet loss etc.)
PC5 signal strength (e.g., RSRP, RSRQ, RSSI, SINR, SIR) of the link between the remote UE and the serving relay UE is below a configured threshold
Uu signal strength (e.g., RSRP, RSRQ, RSSI, SINR, SIR) of the link between the serving relay UE and its gNB is below a configured threshold
PC5 load (e.g channel busy ratio (CBR) or channel usage ratio (CR)) of the link between the remote UE and the serving relay UE is above a configured threshold
Load of the cell of the serving relay UE is above a configured threshold. The load may be measured in terms of e.g., the number of UEs being served in the cell, the PRB utilization ratio etc)
Preference Policy of Relay type selection is updated.

For any one of the above conditions, the remote UE may also apply a time threshold. In other words, the relay UE reselection may be triggered only when at least one of the above conditions is met for a (pre)configured time period. In addition, in some embodiments, for any one of the above conditions, the new relay UE needs to give better condition compared to the old relay UE.

Some embodiments of the present disclosure are described below with respect to gNB actions on handling coexistence of L2 relaying and L3 relaying.

In some embodiments, a gNB may be determined as L3 relaying capable if at least one of the below conditions is met:
the gNB has signaled discovery configuration (e.g., discovery resources, discovery measurement gap, PC5 RSRP threshold for triggering relay reselection) to UEs in the cell.
the gNB has signaled indicators which explicitly or inexplicitly indicate that the gNB is capable of L3 relaying operation. In addition, the gNB may signal in which conditions L3 relaying operation is supported.

In some embodiments, a gNB may be determined as L2 relaying capable if at least one of the below conditions is met
the gNB has signaled discovery configuration (e.g., discovery resources, discovery measurement gap, PC5 RSRP threshold for triggering relay reselection) to UEs in the cell.
the gNB has signaled indicators which explicitly or inexplicitly indicate that the gNB is capable of L2 relaying operation. In addition, the gNB may signal in which conditions L2 relaying operation is supported.

In some embodiments, a gNB may signal a L3 relay specific discovery configuration to UEs in the cell. In some embodiments, a gNB may signal a L2 relay specific discovery configuration to UEs in the cell.

In some embodiments, a gNB may be capable of both L2 relay operation and L3 relay operation. The gNB may signal both L2 relay specific and L3 specific discovery configuration to UEs in the cell. In some embodiments, the gNB may signal its capability of both L2 and L3 relaying operation and/or a preference on whether L2 or L3 relay operation is prioritized, and in which conditions both L2 and L3 relaying operation are supported.

In some embodiments, a gNB may decide to change its SL relay operation/preference from one relay option (e.g., L2 relay or L3 relay) to another relay option (e.g., L3 relay or L2 relay). In an example, the gNB currently applies/prefers L2 relay operation, but the gNB decides to apply/prefer L3 relay operation instead. In another example, the gNB currently applies/prefers L3 relay operation, but the gNB decides to apply/prefer L2 relay operation instead.

In some embodiments, a gNB may signal its capability/configuration on SL relay operation (i.e., support/prefer L2 relaying or L3 relaying) to another gNB via inter-gNB signaling, i.e. Xn interface.

In some embodiments, a gNB may not signal UEs on whether the gNB supports/prefers which relay option.

In some embodiments, in case the gNB receives a connection setup request from a remote UE or a relay UE associated with a relay option which the gNB may not want to serve, the gNB may reject the request. Meanwhile, the gNB may also indicate at least one of the following information to the UE.
Reject reason for the request (e.g., the requested relay option is not matching to gNB's preference)
Suggested other gNBs or cells that the UE can re-direct to
Relevant configurations (e.g., discovery configurations) of the suggested other gNBs or cells that the UE can re-direct to.

In some embodiments, a remote UE may redirect/access to other relay UEs connecting to other gNBs or cells if the remote UE has received a rejection response from the gNB. In some embodiments, a relay UE may redirect/access to other gNBs or cells for a remote UE if the request initiated by the remote UE (together with the relay UE) has been rejected by the gNB. In this case, the remote UE doesn't need to reselect another relay UE upon reception of the reject message from the gNB.

In some embodiments, during a handover procedure for a relay UE, the serving gNB/cell may signal the relay UE's capability/configuration on SL relay operation (i.e., support/preference of L2 relaying or L3 relaying) as UE context to a target gNB/cell via signaling such as handover request, the target gNB can decide whether to accept or reject the relay UE's handover request based on the received information. In some embodiments, the serving gNB/cell may also signal the capability/configuration on SL relay operation (i.e., support/preference of L2 relaying or L3 relaying) of target gNB/cell to the relay UE via signaling such as handover command.

In some embodiments, for any one of the above embodiments, any necessary configuration is configured to the UE by a network node such as gNB or a UE (e.g., a controlling UE, or a relay UE) via at least one of the below signaling alternative.
system information
RRC signalling (e.g., Uu RRC or PC5-RRC).
   In this case, different capability/configuration may be signaled to different UEs, e.g. the gNB signals to some UEs that L2 relay is supported/preferred while signals to some other UEs that L3 relay is supported/preferred.
MAC CE
Paging message
Control PDU of a protocol layer (e.g., SDAP, PDCP, RLC, or an adaptation layer in case of SL relay)
L1 signalling such as DCI, or SCI
Pre-configured (hard-coded) in the specification.

In some embodiments, a network node such as gNB or a controlling UE may include a configuration for the remote UE in the RRC message sent to the relay UE ((as separate IEs or within a container), the relay UE may then forward the configuration to the remote UE using PC5-RRC. In case the container is used, the relay UE can simply put the container in its PC5-RRC w/o decoding it.

In some embodiments, for any one of the above embodiments, there may be some necessary configuration which is signaled by the core network entity (e.g., SMF or AMF) to gNB or UEs. In an example, a relay option may be provisioned to a UE.

With the embodiments of the present disclosure, necessary signaling details to support coexistence of L2 relaying and L3 relaying are defined for both UE and gNB. Further, criteria may be defined for a UE to determine relaying options/capabilities of a gNB/cell during relay selection and reselection procedure. Furthermore, for UE capable of both L2 relaying and L3 relaying, criteria may be defined for the UE on how to determine a suitable relaying option.

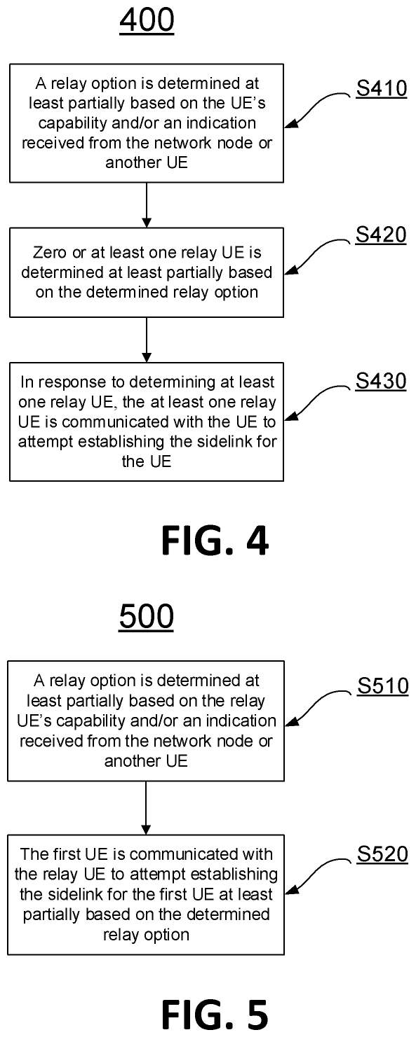

FIG. 4 is a flow chart of an exemplary method 400 at a remote UE for communicating with a network node according to an embodiment of the present disclosure. In some embodiments, the communication is relayed over a sidelink. The method 400 may be performed at a remote UE (e.g., the remote UE 210) for communicating with the RAN node 230. The method 400 may comprise steps S410, S420, and S430. However, the present disclosure is not limited thereto. In some other embodiments, the method 400 may comprise more steps, less steps, different steps, or any combination thereof. Further the steps of the method 400 may be performed in a different order than that described herein. Further, in some embodiments, a step in the method 400 may be split into multiple sub-steps and performed by different entities, and/or multiple steps in the method 400 may be combined into a single step.

The method 400 may begin at step S410 where a relay option may be determined at least partially based on the UE's configuration and/or an indication received from the network node or another UE.

At step S420, zero or at least one relay UE may be determined at least partially based on the determined relay option.

At step S430, in response to determining at least one relay UE, the UE may communicate with the at least one relay UE to attempt establishing the sidelink for the UE.

In some embodiments, the relay option comprises one of: —L2 relaying is supported; —L3 relaying is supported; and—both L2 relaying and L3 relaying are supported. In some embodiments, the UE's configuration comprises its relaying capability and/or relaying preference. In some embodiments, the step of determining a relay option at least partially based on the UE's configuration and/or an indication received from the network node or another UE comprises: determining the relay option based on the indication received from the network node or the other UE in response to determining that the UE's configuration is different from the configuration or configuration on relay option indicated by the network node or the other UE. In some embodiments, the UE's configuration is configured and/or preconfigured in Mobile Equipment (ME) or Universal Integrated Circuit Card (UICC) of the UE. In some embodiments, the indication is received from the network node or the other UE via broadcasted system information, dedicated Radio Resource Control (RRC) signaling, and/or a Medium Access Control (MAC) Control Element (CE).

In some embodiments, the step of determining zero or at least one relay UE at least partially based on the determined relay option comprises: broadcasting or transmitting, to each of one or more neighboring UEs, a discovery message indicating the determined relay option; and receiving, from each of one or more of the neighboring UEs, an indication, each indication indicating that the determined relay option is supported at a corresponding neighboring UE as a candidate relay UE; and determining at least one of the one or more candidate relay UEs as the determined relay UE.

In some embodiments, the step of determining zero or at least one relay UE at least partially based on the determined relay option comprises: receiving, from one or more candidate relay UEs, one or more discovery messages comprising one or more indications indicating their relay options, respectively; and determining at least one of the one or more candidate relay UEs as the determined relay UE at least partially based on the determined relay option and the received one or more indications. In some embodiments, at least one of the received indications indicates that a relay option of a corresponding candidate relay UE is supported by its serving or camping network node.

In some embodiments, the step of determining at least one of the one or more candidate relay UEs as the determined relay UE comprises: determining, from the one or more candidate relay UEs, a candidate relay UE with the highest PC5 signal strength as the determined relay UE in response to determining that the relay option of the UE indicates that both L2 relaying and L3 relaying are supported. In some embodiments, the step of determining at least one of the one or more candidate relay UEs as the determined relay UE comprises: determining a candidate relay UE, which is first discovered to support L2 relaying, as the determined relay UE in response to determining that the relay option of the UE indicates that L2 relaying is prioritized over L3 relaying and determining that at least one candidate relay UE supporting at least L2 relaying is discovered; determining a candidate relay UE, which supports only L3 relaying, as the determined relay UE in response to determining that the relay option of the UE indicates that L2 relaying is prioritized over L3 relaying and determining that no candidate relay UE supporting L2 relaying is discovered; determining a candidate relay UE, which is first discovered to support at least L3 relaying, as the determined relay UE in response to determining that the relay option of the UE indicates that L3 relaying is prioritized over L2 relaying and determining that at least one candidate relay UE supporting at least L3 relaying is discovered; and determining a candidate relay UE, which supports only L2 relaying, as the determined relay UE in response to determining that the relay option of the UE indicates that L3 relaying is prioritized over L2 relaying and determining that no candidate relay UE supporting L3 relaying is discovered. In some embodiments, the step of determining at least one of the one or more candidate relay UEs as the determined relay UE comprises: determining a signal strength offset for each candidate relay UE at least partially based on the indication received from the corresponding candidate relay UE; and determining, from the one or more candidate relay UEs, a candidate relay UE with the greatest sum of the measured signal strength and the corresponding signal strength offset as the determined relay UE. In some embodiments, the step of determining a signal strength offset for each candidate relay UE at least partially based on the indication received from the corresponding candidate relay UE comprises at least one of: determining the signal strength offset as a positive value in response to determining that the relay option indicated by the candidate relay UE is compatible with and prioritized by the relay option of the UE; and determining the signal strength offset as a negative value in response to determining that the relay option indicated by the candidate relay UE is not compatible with or the relay option indicated by the candidate relay UE is not prioritized by the relay option of the UE.

In some embodiments, the step of determining zero or at least one relay UE at least partially based on the determined relay option comprises determining the zero or at least one relay UE further based on one or more of following criteria: —a Quality of Service (QOS) requirement of a service or flow which needs to be relayed; —load of the serving cell of a candidate relay UE; —load of a candidate relay UE; and—an access restriction on a cell of interest. In some embodiments, the step of determining zero or at least one relay UE at least partially based on the determined relay option comprises determining the zero or at least one relay UE by at least one of: prioritizing a candidate relay UE supporting L2 relaying over a candidate relay UE supporting L3 relaying in response to determining that the QoS requirement indicates a stricter requirement; prioritizing a candidate relay UE supporting L3 relaying over a candidate relay UE supporting L2 relaying in response to determining that the QoS requirement indicates a less strict requirement; prioritizing a candidate relay UE supporting L2 relaying over a candidate relay UE supporting L3 relaying in response to determining that the QoS requirement indicates a stronger service continuity; prioritizing a candidate relay UE supporting L3 relaying over a candidate relay UE supporting L2 relaying in response to determining that the QoS requirement indicates a weaker service continuity; prioritizing a candidate relay UE supporting L2 relaying over a candidate relay UE supporting L3 relaying in response to determining that the cell has a low or medium cell load; prioritizing a candidate relay UE supporting L3 relaying over a candidate relay UE supporting L2 relaying in response to determining that the cell has a high cell load; prioritizing a candidate relay UE supporting L2 relaying over a candidate relay UE supporting L3 relaying in response to determining that the cell has a less strict access restriction; and prioritizing a candidate relay UE supporting L3 relaying over a candidate relay UE supporting L2 relaying in response to determining that the cell has a stricter access restriction.

In some embodiments, the method further comprises: transmitting, to the network node, a report message indicating that there is no relay UE supporting the determined relay option for the sidelink in response to determining so. In some embodiments, the report message comprises at least one of: —a failure cause; —the determined relay option; and—one or more discovery models used for discovering relay UE. In some embodiments, the report message is transmitted to the network node via at least one of: —RRC signaling; and—MAC CE. In some embodiments, the step of transmitting, to the network node, a report message comprises one of: transmitting, to the network node, the report message directly; and transmitting, to the network node, the report message indirectly via a relay UE with a different relay option than the determined relay option.

In some embodiments, the method further comprises: determining an updated relay option at least partially based on the UE's updated configuration and/or an updated indication received from the network node or another UE; keeping communicating with the current serving relay UE for sidelink communication in response to determining that the current serving relay UE supports the updated relay option. In some embodiments, the method further comprises: communicating with a first relay UE supporting a first relay option for a first service or flow and with a second relay UE supporting a second relay option for a second service or flow, wherein the first relay option is different from the second relay option, wherein the first service or flow is different from the second service or flow. In some embodiments, the first relay UE and the second relay UE are served by a same network node or different network nodes.

In some embodiments, the method further comprises: selecting a candidate relay UE which supports a different relay option than that of the current serving relay UE as the reselected relay UE in response to determining at least one of the following conditions is met: —a QoS requirement of a service or flow which is being relayed by the current serving relay UE cannot be fulfilled; —a PC5 signal strength of the link between the UE and the current serving relay UE is below a configured threshold; —a Uu signal strength of the link between the current serving relay UE and its serving network node is below a configured threshold; —a PC5 load of the link between the UE and the current serving relay UE is above a configured threshold; —a load of the serving cell of the current serving relay UE is above a configured threshold; and—a preference policy of relay option is updated. In some embodiments, the step of determining that a condition is met comprises: determining that the condition is met for a configured time threshold. In some embodiments, the reselected relay UE is the current serving relay UE supporting a relay option which is compatible with the different relay option. In some embodiments, the step of selecting a candidate relay UE which supports a different relay option than that of the current serving relay UE as a new relay UE comprises: selecting a candidate relay UE which supports a different relay option than that of the current serving relay UE and which meets at least one of conditions in a better manner than the current serving relay UE, as the reselected relay UE.

FIG. 5 is a flow chart of an exemplary method 500 at a relay UE for facilitating a first UE in communicating with a network node according to an embodiment of the present disclosure. In some embodiments, the communication may be relayed over a sidelink. The method 500 may be performed at a relay UE (e.g., the relay UE 220) for facilitating a UE in transmission over a sidelink. The method 500 may comprise steps S510 and S520. However, the present disclosure is not limited thereto. In some other embodiments, the method 500 may comprise more steps, less steps, different steps, or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510 where a relay option may be determined at least partially based on the relay UE's configuration and/or an indication received from the network node or another UE.

At step S520, the relay UE may communicate with the first UE to attempt establishing the sidelink for the first UE at least partially based on the determined relay option.

In some embodiments, the relay option comprises one of: —L2 relaying is supported; —L3 relaying is supported; and—both L2 relaying and L3 relaying are supported. In some embodiments, the relay UE's configuration comprises its relaying capability and/or relaying preference. In some embodiments, the step of determining a relay option at least partially based on the relay UE's configuration and/or an indication received from the network node or another UE comprises: determining the relay option based on the indication received from the network node or the other UE in response to determining that the relay UE's configuration is different from the indication received from the network node or the other UE. In some embodiments, the relay UE's configuration is configured and/or preconfigured in Mobile Equipment (ME) or Universal Integrated Circuit Card (UICC) of the UE. In some embodiments, the indication is received from the network node or the other UE via broadcasted system information, dedicated Radio Resource Control (RRC) signaling, and/or a Medium Access Control (MAC) Control Element (CE). In some embodiments, the step of communicating with the first UE to attempt establishing the sidelink for the first UE at least partially based on the determined relay option comprises: broadcasting or transmitting, to the first UE, a discovery message indicating the determined relay option; and receiving, from the first UE, an indication indicating that the determined relay option is supported; and relaying data between the first UE and the network node for sidelink communication.

In some embodiments, the step of communicating with the first UE to attempt establishing the sidelink for the first UE at least partially based on the determined relay option comprises: receiving, from the first UE, a discovery message comprising an indication indicating its relay option; determining whether the first UE can be served or not for sidelink communication at least partially based on the determined relay option and the received indication; and relaying data between the first UE and the network node for sidelink communication in response to determining that the first UE can be served for sidelink communication. In some embodiments, the received indication indicates that a relay option of the first relay UE is supported by its serving or camping network node. In some embodiments, the method further comprises: receiving, from the network node, a signal strength offset for the relay UE; determining the sum of a measured signal strength for the first UE and/or the network node and the signal strength offset; and transmitting, to the first UE and/or the network node, the determined sum. In some embodiments, the signal strength offset is a positive value in response to determining that the determined relay option is compatible with and prioritized by the relay option of the network node, wherein the signal strength offset is a negative value in response to determining that the determined relay option is not compatible with or the determined relay option is not prioritized by the relay option of the network node.

In some embodiments, the method further comprises: receiving, from the first UE, a report message indicating that there is no relay UE supporting its desired relay option for the sidelink; and transmitting, to the network node, the report message or another report message, which is generated based on the report message, indicating that there is no relay UE supporting the first UE's desired relay option. In some embodiments, any of the report messages comprises at least one of: —a failure cause; —the determined relay option; and—one or more discovery models used for discovering relay UE. In some embodiments, the report message is received from the first UE and/or transmitted to the network node via at least one of: —RRC signaling; and—MAC CE.

In some embodiments, the method further comprises: determining an updated relay option at least partially based on the relay UE's updated configuration and/or an updated indication received from the network node or another UE; keeping communicating with the first UE for sidelink communication in response to determining that the first UE supports the updated relay option.

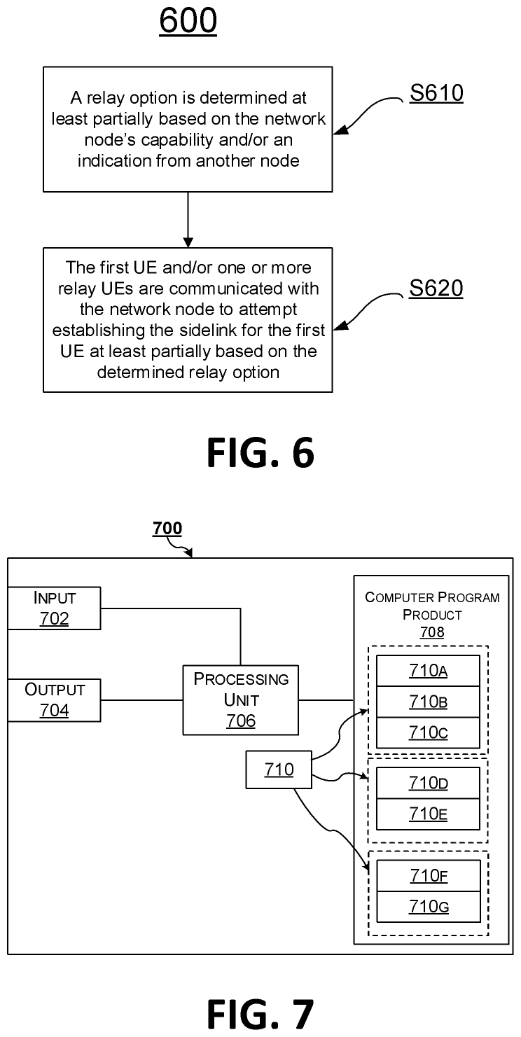

FIG. 6 is a flow chart of an exemplary method 600 at a network node for communicating with a first UE according to an embodiment of the present disclosure. In some embodiments, the communication may be relayed over a sidelink. The method 600 may be performed at a network node (e.g., the RAN node 230) for communicating a UE in transmission over a sidelink. The method 600 may comprise steps S610 and S620. However, the present disclosure is not limited thereto. In some other embodiments, the method 600 may comprise more steps, less steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where a relay option may be determined at least partially based on the network node's configuration and/or an indication from another node.

At step S620, the network node may communicate with the first UE and/or one or more relay UEs to attempt establishing the sidelink for the first UE at least partially based on the determined relay option.

In some embodiments, the relay option comprises one of: —L2 relaying is supported; —L3 relaying is supported; and—both L2 relaying and L3 relaying are supported. In some embodiments, the network node's configuration comprises its relaying capability and/or relaying preference. In some embodiments, the step of determining the relay option comprises at least one of: determining the relay option as being compatible with “L3 relaying is supported” in response to determining that the network node has signaled its discovery configuration for L3 relaying to UEs in its coverage; and determining the relay option as being compatible with “L3 relaying is supported” in response to determining that the network node has signaled an indication indicating its support of L3 relaying to UEs in its coverage. In some embodiments, the indication further indicates one or more conditions under which L3 relaying is supported.

In some embodiments, the step of determining the relay option comprises at least one of: determining the relay option as being compatible with “L2 relaying is supported” in response to determining that the network node has signaled its discovery configuration for L2 relaying to UEs in its coverage; and determining the relay option as being compatible with “L2 relaying is supported” in response to determining that the network node has signaled an indication indicating its support of L2 relaying to UEs in its coverage. In some embodiments, the indication further indicates one or more conditions under which L2 relaying is supported. In some embodiments, the discovery configuration comprises at least one of: —discovery resources; —discovery measurement gap; —PC5 Reference Signal Received Power (RSRP) threshold for triggering relay reselection. In some embodiments, the discovery configuration comprises an L2 relay specific discovery configuration and/or an L3 relay specific discovery configuration.

In some embodiments, the method further comprises: transmitting or broadcasting, to the first UE and/or one or more relay UEs, one or more of: —the network node's capability in supporting both L2 and L3 relaying, —the network node's preference on whether L2 or L3 relaying is prioritized; and—one or more conditions under which L2 and/or L3 relaying are supported. In some embodiments, the method further comprises: determining an updated relay option at least partially based on the network node's updated configuration and/or an updated indication from another node; communicating with the first UE and/or one or more relay UEs to attempt establishing the sidelink for the first UE at least partially based on the updated relay option.

In some embodiments, the method further comprises: transmitting, to another network node, its determined relay option and/or discovery configuration for sidelink communication. In some embodiments, the step of communicating with the first UE and/or one or more relay UEs to attempt establishing the sidelink for the first UE at least partially based on the determined relay option comprises: preventing the determined relay option and/or the discovery configuration from being transmitted or broadcasted to the first UE and/or any relay UE. In some embodiments, the step of communicating with the first UE and/or one or more relay UEs to attempt establishing the sidelink for the first UE at least partially based on the determined relay option further comprises: receiving, from the first UE or a relay UE with a relay option not supported and/or prioritized, a connection setup request; and transmitting, to the first UE or the relay UE, a rejection message indicating a rejection to the connection setup request. In some embodiments, the rejection message comprises at least one of: —a rejection reason; —one or more suggested network nodes that the first UE or the relay UE can access; and—one or more configurations of the one or more suggested network nodes that the first UE or the relay UE can access.

In some embodiments, the method further comprises: transmitting, to a target network node, a relay UE's relay option and/or discovery configurations as a part of the relay UE's context in response to determining that the relay UE is to be handed over to the target network node; and/or transmitting, to a relay UE, a target network node's relay option and/or discovery configurations as a part of a handover command in response to determining that the relay UE is to be handed over to the target network node.

In some embodiments, the method further comprises: receiving, from a target network node, a relay UE's relay option and/or discovery configurations as a part of the relay UE's context; and determining whether the relay UE is accepted at least partially based on the received relay option and/or discovery configurations. In some embodiments, the indication and/or discovery configuration of the network node is determined at the first UE via at least one of: —broadcasted system information; —dedicated RRC signaling; —a MAC CE; —a paging message; —a control packet data unit (PDU) from a protocol layer; —an L1 signaling; and—a pre-configured or hard-coded configuration at the first UE. In some embodiments, the indication and/or discovery configuration is transmitted from the network node to the first UE via a relay UE via an RRC message. In some embodiments, at least a part of the relay option and/or discovery configurations of the network node, the first UE, and/or one or more relay UEs is signaled from a core network node. In some embodiments, the method further comprises, for each of one or more relay UE: determining a signal strength offset for the relay UE at least partially based on an indication received from the relay UE; transmitting, to the relay UE, the determined signal strength offset; receiving, from the relay UE, a sum of its measured signal strength and the signal strength offset; and determining whether the first UE can be served by the relay UE for sidelink communication or not. In some embodiments, the step of determining a signal strength offset for the relay UE at least partially based on an indication received from the relay UE comprises at least one of: determining the signal strength offset as a positive value in response to determining that the relay option indicated by the relay UE is compatible with and prioritized by the relay capability and/or relay preference of the network node; and determining the signal strength offset as a negative value in response to determining that the relay option indicated by the relay UE is not compatible with or the relay option indicated by the relay UE is not prioritized by the relay capability and/or relay preference of the network node.

FIG. 7 schematically shows an embodiment of an arrangement which may be used in a network node, a remote UE and/or a relay UE according to an embodiment of the present disclosure. Comprised in the arrangement 700 are a processing unit 706, e.g., with a Digital Signal Processor (DSP) or a Central Processing Unit (CPU). The processing unit 706 may be a single unit or a plurality of units to perform different actions of procedures described herein. The arrangement 700 may also comprise an input unit 702 for receiving signals from other entities, and an output unit 704 for providing signal(s) to other entities. The input unit 702 and the output unit 704 may be arranged as an integrated entity or as separate entities.

Furthermore, the arrangement 700 may comprise at least one computer program product 708 in the form of a non-volatile or volatile memory, e.g., an Electrically Erasable Programmable Read-Only Memory (EEPROM), a flash memory and/or a hard drive. The computer program product 708 comprises a computer program 710, which comprises code/computer readable instructions, which when executed by the processing unit 706 in the arrangement 700 causes the arrangement 700 and/or the remote UE and/or the relay UE and/or the network node in which it is comprised to perform the actions, e.g., of the procedure described earlier in conjunction with FIG. 4 through FIG. 6 or any other variant.

The computer program 710 may be configured as a computer program code structured in computer program modules 710A-710C. Hence, in an exemplifying embodiment when the arrangement 700 is used in the remote UE, the code in the computer program of the arrangement 700 includes: a module 710A for determining a relay option at least partially based on the UE's configuration and/or an indication received from the network node or another UE; a module 710B for determining zero or at least one relay UE at least partially based on the determined relay option; and a module 710C for in response to determining at least one relay UE, communicating with the at least one relay UE to attempt establishing the sidelink for the UE.

The computer program 710 may be further configured as a computer program code structured in computer program modules 710D-710E. Hence, in an exemplifying embodiment when the arrangement 700 is used in the relay UE, the code in the computer program of the arrangement 700 includes: a module 710D for determining a relay option at least partially based on the relay UE's configuration and/or an indication received from the network node or another UE; a module 710E for communicating with the first UE to attempt establishing the sidelink for the first UE at least partially based on the determined relay option.

The computer program 710 may be further configured as a computer program code structured in computer program modules 710F-710G. Hence, in an exemplifying embodiment when the arrangement 700 is used in the network node, the code in the computer program of the arrangement 700 includes: a module 710F for determining a relay option at least partially based on the network node's configuration and/or an indication from another node; a module 710G for communicating with the first UE and/or one or more relay UEs to attempt establishing the sidelink for the first UE at least partially based on the determined relay option.

The computer program modules could essentially perform the actions of the flow illustrated in FIG. 4 through FIG. 6, to emulate the remote UE, the relay UE, or the network node. In other words, when the different computer program modules are executed in the processing unit 706, they may correspond to different modules in the network node, the remote UE or the relay UE.

Although the code means in the embodiments disclosed above in conjunction with FIG. 7 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the remote UE, the relay UE, and/or the network node.

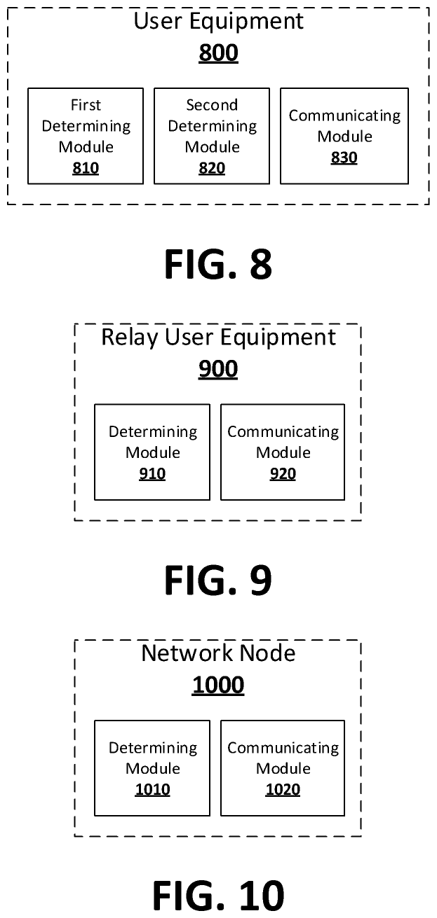

Correspondingly to the method 400 as described above, an exemplary user equipment is provided. FIG. 8 is a block diagram of a UE 800 according to an embodiment of the present disclosure. The UE 800 may be, e.g., the UE 100-2, 100-3 or 210 in some embodiments.

The UE 800 may be configured to perform the method 400 as described above in connection with FIG. 4. As shown in FIG. 8, the UE 800 may comprise a first determining module 810 for determining a relay option at least partially based on the UE's configuration and/or an indication received from the network node or another UE; a second determining module 820 for determining zero or at least one relay UE at least partially based on the determined relay option; and a communicating module 830 for in response to determining at least one relay UE, communicating with the at least one relay UE to attempt establishing the sidelink for the UE.

The above modules 810, 820, and/or 830 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4. Further, the UE 800 may comprise one or more further modules, each of which may perform any of the steps of the method 400 described with reference to FIG. 4.

Correspondingly to the method 500 as described above, an exemplary relay user equipment is provided. FIG. 9 is a block diagram of a relay UE 900 according to an embodiment of the present disclosure. The UE 900 may be, e.g., the UE 100-1 or 220 in some embodiments.

The UE 900 may be configured to perform the method 500 as described above in connection with FIG. 5. As shown in FIG. 9, the UE 900 may comprise a determining module 910 for determining a relay option at least partially based on the relay UE's configuration and/or an indication received from the network node or another UE; and a communicating module 920 for communicating with the first UE to attempt establishing the sidelink for the first UE at least partially based on the determined relay option.

The above modules 910 and/or 920 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the UE 900 may comprise one or more further modules, each of which may perform any of the steps of the method 500 described with reference to FIG. 5.

Correspondingly to the method 600 as described above, a network node is provided. FIG. 10 is a block diagram of an exemplary network node 1000 according to an embodiment of the present disclosure. The network node 1000 may be, e.g., the RAN node 105 or 230 in some embodiments.

The network node 1000 may be configured to perform the method 600 as described above in connection with FIG. 6. As shown in FIG. 10, the network node 1000 may comprise a determining module 1010 for determining a relay option at least partially based on the network node's configuration and/or an indication from another node; and a communicating module 1020 for communicating with the first UE and/or one or more relay UEs to attempt establishing the sidelink for the first UE at least partially based on the determined relay option.

The above modules 1010 and/or 1020 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6. Further, the network node 1000 may comprise one or more further modules, each of which may perform any of the steps of the method 600 described with reference to FIG. 6.

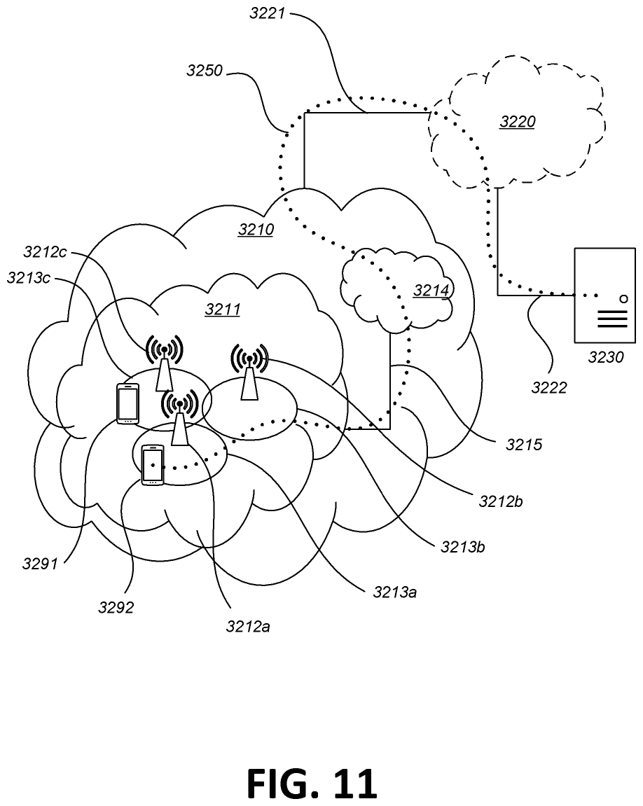

With reference to FIG. 11, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

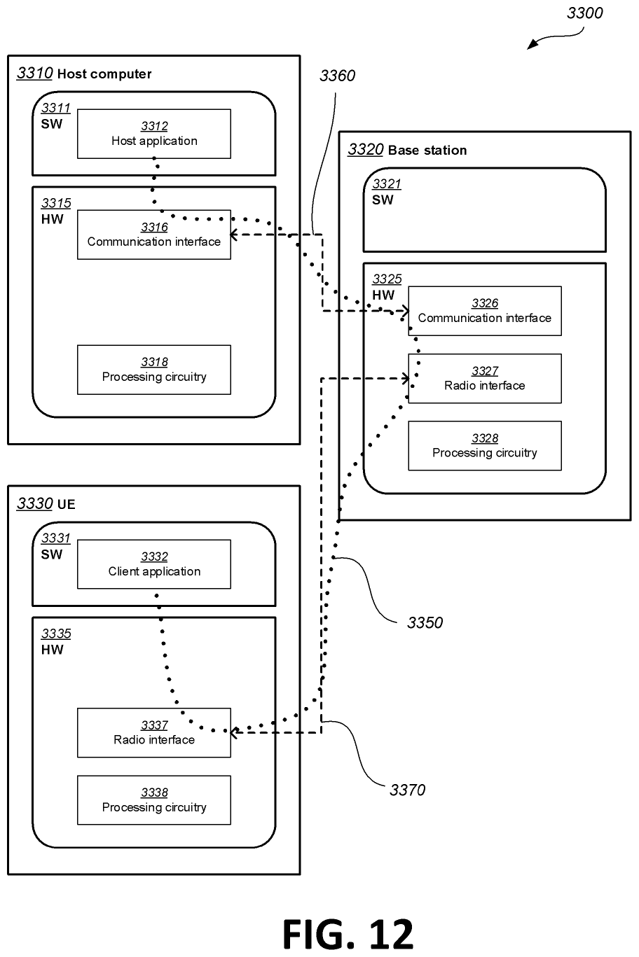

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 12) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

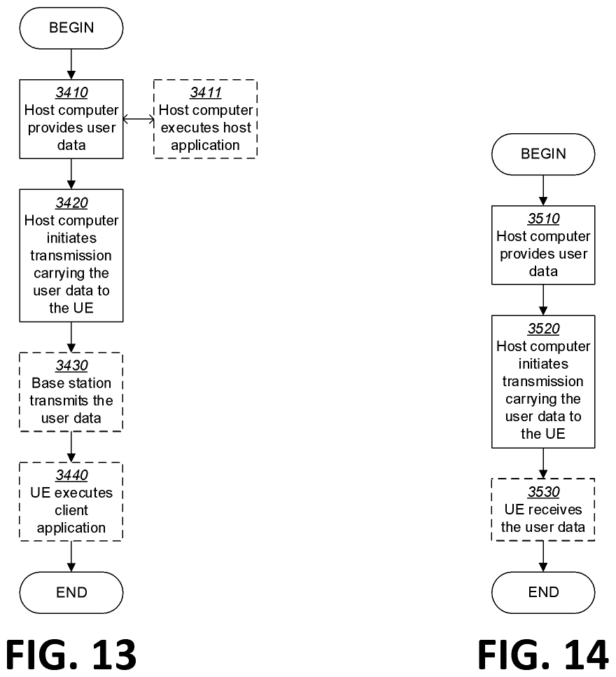

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

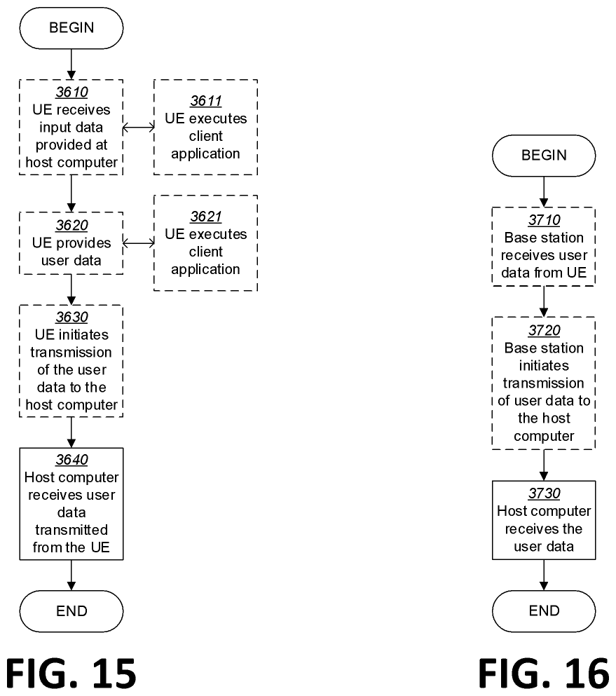

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| CA | Carrier Aggregation |
| CBR | Channel Busy Ratio |
| CQI | Channel Quality Indicator |
| CSI | Channel State Information |
| DFN | Direct Frame Number |
| DL | Downlink |
| DRX | Discontinuous Reception |
| FDD | Frequency Division Duplex |
| GNSS | Global Navigation Satellite System |
| HARQ | Hybrid automatic repeat request |
| IE | Information Element |
| MAC | Medium Access Control |
| MIB | Master Information Block |
| NSPS | National Security and Public Safety |
| OoC | Out-of-Coverage |
| PDCCH | Physical Downlink Control Channel |
| PDCP | Packet Data Convergence Protocol |
| PDU | Protocol Data Unit |
| PHY | Physical (layer) |
| PL | Path Loss |
| PMI | Precoding Matrix Indicator |
| ProSe | Proximity Services |
| PSCCH | Physical Sidelink Control Channel |
| PSSCH | Physical Sidelink Shared Channel |
| RL | Relay |
| RLC | Radio link control |
| RM | Remote |
| RI | Rank Indicator |
| RRC | Radio Resource Control |
| RSRP | Reference Signal Received Power |
| RSSI | Received Signal Strength Indicator |
| RX | Receive, receiver |
| SFN | System Frame Number |
| SIB | System Information Block |
| SINR | Signal to interference noise ration |
| SL | Sidelink |
| SLRB | Sidelink Radio Bearer |
| SLSS | Sidelink Synchronization Signals |
| SMF | Session Management Function |
| SynchUE | Synchronization UE |
| TDD | Time Division Duplex |
| TETRA | Terrestrial Trunked Radio |
| TA | Time advance |
| TX | Transmit, transmitter |
| UE | User Equipment |
| UL | Uplink |
| UPF | User Plane Function |
| V2V | Vehicle-to-vehicle |
| V2X | Vehicle-to-anything |

1-69. (canceled)

70. A method at a user equipment (UE) for communicating with a network node for relaying communication over a sidelink, the method comprising:
determining a relay option at least partially based on a configuration of the UE and/or an indication received from the network node or another UE;
determining zero or at least one relay UE (220) at least partially based on the determined relay option; and
in response to determining the at least one relay UE, communicating with the at least one relay UE to attempt establishing the sidelink for the UE.

71. The method of claim 70, wherein the relay option comprises one of:
layer 2 (L2) relaying is supported;
layer 3 (L3) relaying is supported; and
both L2 relaying and L3 relaying are supported;
wherein the configuration of the UE comprises a relaying capability and/or a relaying preference of the UE.

72. The method claim 70, wherein the step of determining a relay option at least partially based on the configuration of the UE and/or an indication received from the network node or another UE comprises:
determining the relay option based on the indication received from the network node or the other UE in response to determining that the configuration of the UE is different from the indication or a configuration on relay option indicated by the network node or the other UE.

73. The method of claim 70, wherein the configuration of the UE is configured and/or preconfigured in Mobile Equipment (ME) or Universal Integrated Circuit Card (UICC) of the UE; or
wherein the indication is received from the network node or the other UE via broadcasted system information, dedicated Radio Resource Control (RRC) signaling, and/or a Medium Access Control (MAC) Control Element (CE).

74. The method of claim 70, wherein the step of determining zero or at least one relay UE at least partially based on the determined relay option comprises:
receiving, from one or more candidate relay UEs, one or more discovery messages comprising one or more indications indicating their relay options, respectively; and
determining at least one of the one or more candidate relay UEs as the determined relay UE at least partially based on the determined relay option and the received one or more indications;
wherein at least one of the received one or more indications indicates that a relay option of a corresponding candidate relay UE is supported by its serving or camping network node.

75. The method of claim 74, wherein the step of determining at least one of the one or more candidate relay UEs as the determined relay UE comprises:
determining, from the one or more candidate relay UEs, a candidate relay UE with a highest PC5 signal strength as the determined relay UE in response to determining that the relay option of the UE indicates that both L2 relaying and L3 relaying are supported.

76. The method claim 74, wherein the step of determining at least one of the one or more candidate relay UEs as the determined relay UE comprises:
determining a signal strength offset for each candidate relay UE at least partially based on the indication received from the corresponding candidate relay UE; and
determining, from the one or more candidate relay UEs, a candidate relay UE with the greatest sum of the measured signal strength and the corresponding signal strength offset as the determined relay UE.

77. The method of claim 70, wherein the step of determining zero or at least one relay UE at least partially based on the determined relay option comprises determining the zero or at least one relay UE further based on one or more of following criteria:
a Quality of Service (QOS) requirement of a service or flow which needs to be relayed;
load of a serving cell of a candidate relay UE;
load of the candidate relay UE; and
an access restriction on a cell of interest.

78. The method of claim 70, further comprising:
transmitting, to the network node, a report message indicating that there is no relay UE supporting the determined relay option for the sidelink in response to determining so;
wherein the report message comprises at least one of:
a failure cause;
the determined relay option; and
one or more discovery models used for discovering the relay UE;
wherein the report message is transmitted to the network node via at least one of:
RRC signaling; and
MAC CE.

79. The method of claim 78, wherein the step of transmitting, to the network node, a report message comprises one of:
transmitting, to the network node, the report message directly; and
transmitting, to the network node, the report message indirectly via a relay UE with a different relay option than the determined relay option.

80. A user equipment (UE), comprising:
a processor;
a memory storing instructions which, when executed by the processor, cause the processor to perform the following:
determining a relay option at least partially based on a configuration of the UE and/or an indication received from a network node or another UE;
determining zero or at least one relay UE at least partially based on the determined relay option; and
in response to determining the at least one relay UE, communicating with the at least one relay UE to attempt establishing a sidelink for the UE.

81. A method at a relay user equipment (UE) for facilitating a first UE in communicating with a network node for relaying communication over a sidelink, the method comprising:
determining a relay option at least partially based on a configuration of the relay UE and/or an indication received from the network node or another UE;
communicating with the first UE to attempt establishing the sidelink for the first UE at least partially based on the determined relay option.

82. The method of claim 81, wherein the relay option comprises one of:
layer 2 (L2) relaying is supported;
layer 3 (L3) relaying is supported; and
both L2 relaying and L3 relaying are supported;
wherein the configuration of the relay UE comprises a relaying capability and/or a relaying preference of the relay UE.

83. The method of claim 81, wherein the step of determining a relay option at least partially based on the configuration of the relay UE and/or an indication received from the network node or another UE comprises:
determining the relay option based on the indication received from the network node or the other UE in response to determining that the configuration of the relay UE is different from the indication received from the network node or the other UE.

84. The method of claim 81, wherein the configuration of the relay UE is configured and/or preconfigured in Mobile Equipment (ME) or Universal Integrated Circuit Card (UICC) of the UE; or
wherein the indication is received from the network node or the other UE via broadcasted system information, dedicated Radio Resource Control (RRC) signaling, and/or a Medium Access Control (MAC) Control Element (CE).

85. The method claim 81, wherein the step of communicating with the first UE to attempt establishing the sidelink for the first UE at least partially based on the determined relay option comprises:
broadcasting or transmitting, to the first UE, a discovery message indicating the determined relay option; and
receiving, from the first UE, an indication indicating that the determined relay option is supported; and
relaying data between the first UE and the network node for sidelink communication.

86. The method of claim 81, wherein the step of communicating with the first UE to attempt establishing the sidelink for the first UE at least partially based on the determined relay option comprises:
receiving, from the first UE, a discovery message comprising an indication indicating its relay option;
determining whether the first UE can be served or not for sidelink communication at least partially based on the determined relay option and the received indication; and
relaying data between the first UE and the network node for sidelink communication in response to determining that the first UE can be served for sidelink communication.

87. The method of claim 85, wherein the received indication indicates that a relay option of the first relay UE is supported by its serving or camping network node.

88. The method of claim 81, further comprising:
receiving, from the network node, a signal strength offset for the relay UE;
determining a sum of a measured signal strength for the first UE and/or the network node and the signal strength offset; and
transmitting, to the first UE and/or the network node, the determined sum;
wherein the signal strength offset is a positive value in response to determining that the determined relay option is compatible with and prioritized by a relay option of the network node,
wherein the signal strength offset is a negative value in response to determining that the determined relay option is not compatible with or the determined relay option is not prioritized by the relay option of the network node.

89. The method of claim 81, further comprising:
receiving, from the first UE, a report message indicating that there is no relay UE supporting a desired relay option of the first UE for the sidelink; and
transmitting, to the network node, the report message or another report message, which is generated based on the report message, indicating that there is no relay UE supporting the desired relay option of the first UE;
wherein the report message or the other report message comprises at least one of:
a failure cause;
the determined relay option; and
one or more discovery models used for discovering the relay UE.
